(19) United States
(12) Patent Application Publication
(10) Pub. No.: US 2026/0288318 A1
(43) Pub. Date: Sep. 24, 2026

(54) INTERACTION METHOD AND APPARATUS, AND ELECTRONIC DEVICE AND STORAGE MEDIUM

(71) Applicant: Beijing Youzhuju Network Technology Co., Ltd., Beijing (CN)

(72) Inventors: Mingyi XIA, Beijing (CN); Jiaqi YAO, Beijing (CN); Kejian SHI, Beijing (CN)

(21) Appl. No.: 19/477,479

(22) PCT Filed: Jun. 14, 2024
(86) PCT No.: PCT/CN2024/099230

§ 371 Date: Oct. 21, 2025

(30) Foreign Application Priority Data
Jun. 16, 2023 (CN) 202310723557.7

(51) Int. Cl. G06F 3/04845; G06F 3/0483; G06F 3/04842

(52) U.S. Cl. CPC G06F 3/04845; G06F 3/0483; G06F 3/04842

(57) ABSTRACT

An interaction method, an electronic device, and a storage medium are provided. The method includes: receiving a display operation for a first page; and displaying the first page in response to the display operation, where the first page includes a preview region and an information region, the preview region is used to display a preview picture corresponding to a second page, the information region is used to display module information of at least part of interaction modules corresponding to the second page, and the preview picture displayed in the preview region corresponds to module information in a selected state in the information region.

The present application claims priority to Chinese Patent Application No. 202310723557.7, filed on Jun. 16, 2023, which is incorporated herein by reference in its entirety as a part of the present application.

### TECHNICAL FIELD

Embodiments of the present disclosure relate in particular to an interaction method and apparatus, an electronic device, and a storage medium.

### BACKGROUND

Currently, in some platforms, some activities are arranged in virtual venues for users to participate in. However, information that a user can view on an activity page is undiversified.

### SUMMARY

Embodiments of the present disclosure provide an interaction method and apparatus, an electronic device, and a storage medium.

According to a first aspect, an embodiment of the present disclosure provides an interaction method, including: receiving a display operation for a first page; and displaying the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

According to a second aspect, an embodiment of the present disclosure further provides an interaction apparatus, including: an operation reception module configured to receive a display operation for a first page; and a page display module configured to display the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

According to a third aspect, an embodiment of the present disclosure further provides an electronic device, including: one or more processors; and a memory configured to store one or more programs, where the one or more programs, when executed by the one or more processors, cause the one or more processors to implement the interaction method according to the embodiment of the present disclosure.

According to a fourth aspect, an embodiment of the present disclosure further provides a computer-readable storage medium having a computer program stored thereon. The program, when executed by a processor, causes the interaction method according to the embodiments of the present disclosure to be implemented.

According to the interaction method and apparatus, the electronic device, and the storage medium provided in the embodiments of the present disclosure, the display operation for the first page is received; and the first page is displayed in response to the display operation, where the first page includes the preview region and the information region, the preview region is used for displaying the preview picture corresponding to the second page, the information region is used for displaying the module information of the at least part of interaction modules corresponding to the second page, and the preview picture displayed in the preview region corresponds to the module information in the selected state in the information region.

### BRIEF DESCRIPTION OF DRAWINGS

The foregoing and other features, advantages, and aspects of embodiments of the present disclosure become more apparent with reference to the following specific implementations and accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of an interaction method according to an embodiment of the present disclosure;

FIG. 2 is a schematic diagram of display of a first page according to an embodiment of the present disclosure;

FIG. 3 is a schematic flowchart of another interaction method according to an embodiment of the present disclosure;

FIG. 4 is a schematic diagram of display of another first page according to an embodiment of the present disclosure;

FIG. 5 is a structural block diagram of an interaction apparatus according to an embodiment of the present disclosure; and

FIG. 6 is a schematic structural diagram of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” and variants thereof used herein indicate open inclusion, that is, “include but are not limited to”. The term “based on” is “at least partially based on”. The term “an embodiment” means “at least one embodiment”. The term “another embodiment” means “at least one another embodiment”. The term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, a user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above-mentioned process of notifying and obtaining the authorization of the user is only illustrative and does not constitute a limitation on the implementations of the present disclosure, and other manners that satisfy the relevant laws and regulations may also be applied in the implementations of the present disclosure.

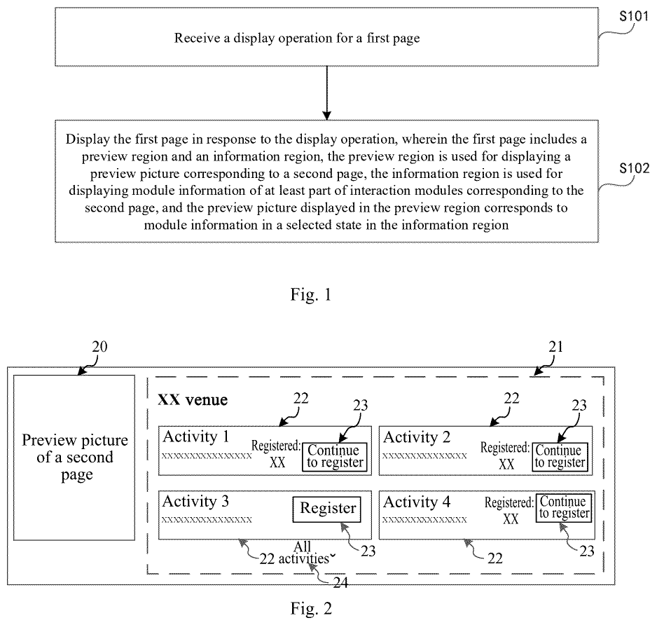

FIG. 1 is a schematic flowchart of an interaction method according to an embodiment of the present disclosure. The method may be performed by an interaction apparatus. The apparatus may be implemented by software and/or hardware, and may be configured in an electronic device, typically in a mobile phone or a tablet computer. The interaction method according to the embodiment of the present disclosure is applicable to a scenario where module information of an interaction module and a preview picture corresponding to another page are displayed in a page, such as a scenario where a preview picture of a virtual venue is displayed in a display page for activity promotion information in the virtual venue. As shown in FIG. 1, the interaction method provided in this embodiment may include the following steps.

S101: Receive a display operation for a first page.

The first page may be a display page of an interaction module. The display operation may be a trigger operation for instructing to display the first page, such as a trigger operation for instructing to switch into the first page. The specific execution method thereof is not limited.

In this embodiment, when intending to view the interaction module or intending to perform interaction through the interaction module, a current user may perform the display operation for the first page. Accordingly, a current application may receive the display operation performed by the current user.

S102: Display the first page in response to the display operation, wherein the first page includes a preview region and an information region, the preview region is used for displaying a preview picture corresponding to a second page, the information region is used for displaying module information of at least part of interaction modules corresponding to the second page, and a preview picture displayed in the preview region corresponds to module information in a selected state in the information region.

Specifically, when the display operation for the first page is received, the first page may be displayed, the preview picture corresponding to the second page is displayed in a preview region 20 of the first page, and module information 22 of at least part of interaction modules corresponding to the second page is displayed in an information region 21 of the first page, as shown in FIG. 2 (the figure shows an example where the interaction module is an activity promotion module in a virtual venue). Here, the preview picture displayed in the preview region 20 corresponds to the module information 22 in the selected state in the information region 21, that is, when module information 22 in a selected state is present in the information region 21, a preview picture corresponding to the module information 22 in the selected state is displayed in the preview region 20. Thus, when the current user selects a piece of module information 22 displayed in the information region 21, a preview picture corresponding to the module information in the preview picture of the second page may be displayed in the preview region.

Here, the interaction module may be a module in the first page for a user to perform interaction, and the module information of the interaction module may be related information of the interaction module, such as a name and/or an introduction of the interaction module. Optionally, the interaction module is an activity promotion module, and the module information is activity promotion information. The activity promotion module may be understood as an interaction module corresponding to a promotion activity. The promotion activity may be, for example, a promotion activity arranged in a venue for a user to participate in, and the activity promotion information may be related information of the promotion activity, such as a name and/or an introduction of the promotion activity. The venue may be a virtual venue or a non-virtual venue.

Taking the interaction module being an activity promotion module arranged in the venue as an example, exemplarily, the venue may be a display venue in which one or more activity promotion modules may be arranged. The activity promotion module may allow the user to add an object to be displayed, so as to display the added object to be displayed. An object to be displayed of an activity promotion module may be understood as an object added in the promotion activity and to be displayed. The object to be displayed may be added by a user, where the user may include, for example, a current user and/or a user other than the current user. The type of the object to be displayed is not limited, for example, the object to be displayed may be a product or commodity to be displayed, or the like.

It should be noted that, the first page may display one or more groups of interaction modules. Interaction modules of the same group may be displayed in the same information region, and different groups of interaction modules may be displayed in different information regions. The same group of interaction modules may correspond to the same second page, and different groups of interaction modules may correspond to different second pages. Taking the interaction module being an activity promotion module in the venue as an example, the first page may display related information of one or more venues, where each venue may have corresponding preview region and information region. A preview region corresponding to a venue may be used for displaying a preview picture of a second page corresponding to the venue, and an information region corresponding to a venue may be used for displaying an activity promotion module for a promotion activity arranged in the venue. In this situation, the first page may include one or more preview regions and one or more information regions, where the preview regions may be in a one-to-one correspondence with the information regions.

Still referring to FIG. 2, the first page may include at least one preview region 20 and at least one information region 21, so that at least part of preview pictures of the second page may be displayed in the preview region 20, and module information 22 of at least part of interaction modules corresponding to the second page may be displayed in the information region 21.

For example, the first page may be a page for adding an object to be displayed for display in the second page, and the second page may be a display page for the object to be displayed that is added in the interaction module. Taking the interaction module being an activity promotion module in the venue as an example, the first page may be a registration page for a promotion activity, namely, a page in which an object to be promoted (i.e., an object to be displayed) is added in the promotion activity, and the second page may be a display page for the promotion activity, such as a display page for the venue to which the promotion activity belongs. A display page (i.e., the second page) corresponding to a venue may be used for displaying related information of the venue, such as venue information of the venue and object information of an object to be displayed in the venue. The object information of the object to be displayed in the venue may include, for example, object information of objects to be displayed that are added in various promotion activities in the venue.

A terminal on which the second page is displayed is not limited. For example, the second page may be displayed on a computer or a mobile phone. Alternatively, the second page and the first page may be displayed on the same type of terminal, or on different types of terminals. For example, when displayed on different types of terminals, the second page may be displayed on a mobile phone, while the first page may be displayed on a computer.

Optionally, the interaction module has a corresponding page component in the second page, and the preview picture corresponding to the module information of the interaction module is a preview picture of the page component corresponding to the respective interaction module.

The second page may include a plurality of page components, and the plurality of page components may include a page component corresponding to the interaction module in the first page. In other words, the second page may be provided with a page component corresponding to the interaction module in the first page, and page components corresponding to different interaction modules may not be exactly the same. For example, different interaction modules may correspond to different page components in the second page, and the different page components may be located at different positions of the second page. A page component corresponding to an interaction module may be configured to display object information of at least part of the objects to be displayed that are added in the interaction module. The object information may be understood as related information of the objects to be displayed, such as pictures, prices, sales, and discounts of the objects to be displayed, or information about stores to which the objects to be displayed belong. Thus, the preview picture displayed in the preview region may be a preview picture of at least part of the page components in the second page. The specific page style of the second page is not limited.

Furthermore, as shown in FIG. 2, when module information 22 of an interaction module is displayed, an object adding control 23 may be further displayed, so that the current user may add an object to be displayed to the interaction module by triggering the object adding control 23.

In some implementations, after the displaying the first page, the method further includes: switching a preview picture displayed in the preview region in response to a preview picture switching operation for the preview region.

Here, the preview picture switching operation may be understood as a trigger operation for instructing to switch the preview picture of the second page displayed in the preview region. The preview picture switching operation may include or exclude a selection operation for a piece of module information. For example, the preview picture switching operation may be a vertical sliding operation acting on the preview region, such as an operation of sliding a mouse wheel after moving an input indicator into the preview region, or a vertical touch sliding operation acting on the preview region.

For example, when the preview picture switching operation for the preview region is received, the preview picture displayed in the preview region may be switched based on the preview picture switching operation. For example, when it is detected that the current user is performing a vertical sliding operation in the preview region, the preview picture currently displayed in the preview region may be controlled to move along the direction of the sliding performed by the user, so as to switch the preview picture currently displayed in the preview region.

In this embodiment, the user is enabled to switch and view the preview pictures of different page components in the second page, thereby meeting the user's various viewing requirements.

The interaction method provided in this embodiment includes receiving a display operation for a first page; and displaying the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region. By adopting the above-mentioned technical solution in this embodiment, when module information of an interaction module is displayed in the first page, a preview picture corresponding to the second page is displayed in association with the module information selected by the user, thus enabling the user to quickly view the preview pictures corresponding to different module information and to quickly know and switch to the second page. In this way, content displayed in the first page and the method of displaying the preview pictures can be diversified, and the difficulty for the user to view the preview pictures corresponding to different interaction modules and switch to the second page can be reduced.

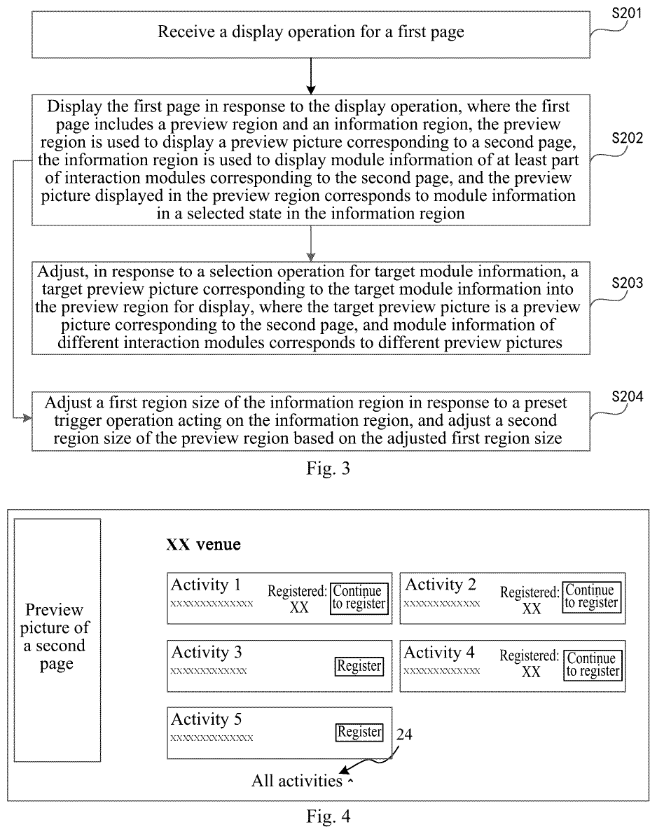

FIG. 3 is a schematic flowchart of another interaction method according to an embodiment of the present disclosure. The solution in this embodiment may be combined with one or more optional solutions in the above-mentioned embodiment. Optionally, after the displaying the first page, the method further includes: adjusting, in response to a selection operation for target module information, a target preview picture corresponding to the target module information into the preview region for display, where the target preview picture is a preview picture corresponding to the second page, and module information of different interaction modules corresponds to different preview pictures.

Optionally, after the displaying the first page, the method further includes: adjusting a first region size of the information region in response to a preset trigger operation acting on the information region, and adjusting a second region size of the preview region based on the adjusted first region size.

Accordingly, as shown in FIG. 3, the interaction method provided in this embodiment may include the following steps.

S201: Receive a display operation for a first page.

S202: Display the first page in response to the display operation, and perform S203 and/or S204, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

S203: Adjust, in response to a selection operation for target module information, a target preview picture corresponding to the target module information into the preview region for display, where the target preview picture is a preview picture corresponding to the second page, and module information of different interaction modules corresponds to different preview pictures.

Here, the selection operation may be a trigger operation for instructing to display a preview picture of a page component corresponding to an interaction module, such as a preset trigger operation for module information of an interaction module. The method of performing the selection operation is not limited. For example, the selection operation may be an operation that triggers a display region of a piece of module information. Optionally, the selection operation includes an operation of enabling an input indicator to hover over the target module information, such as an operation event where the input indicator is moved to a display region of a piece of module information, and a duration during which the input indicator holds still reaches a preset duration. The input indicator may be, for example, a cursor.

The target module information may be understood as module information targeted by the selection operation, that is, module information corresponding to the selection operation. The target preview picture may be understood as a preview picture of the second page corresponding to the target module information, such as a preview picture of a page component corresponding to the interaction module to which the target module information belongs in the second page.

In this embodiment, the module information of different interaction modules may correspond to different preview pictures, such as preview pictures of different regions or page components in the second page. By performing a selection operation, the user may quickly view the preview picture of the page component corresponding to a piece of module information in the second page, for example, the user may quickly view the preview picture when an object to be displayed in an interaction module is displayed in the second page, so that the user can quickly determine the interaction module to which the user intends to add an object to be displayed. In this way, the difficulty of selecting the interaction module is reduced.

Specifically, when a selection operation for module information of an interaction module is received, for example, when it is detected that the current user hovers the input indicator over module information of an interaction module, a target preview picture corresponding to the module information may be displayed in a preview region corresponding to the information region in which the module information is displayed, for example, the preview picture displayed in the preview region may be switched until the target preview picture is adjusted into the preview region for display.

Here, the method of switching the preview picture displayed in the preview region may be set flexibly. For example, based on a relative position in the second page between a page component of the preview picture displayed in the preview region and a page component corresponding to the interaction module, the preview picture displayed in the preview region may be controlled to move until the preview picture of the page component corresponding to the interaction module (i.e., the target preview picture) is moved to a preset position of the preview region for display. The preset position is not limited. For example, the preset position may be a top position, a bottom position, a middle position or the like in the preview region.

In this embodiment, when a target preview picture from the preview pictures in the second page is displayed in the preview region, the target preview picture may have the same display style as or different display styles from the preview pictures other than the target preview picture in the second page. The display style of the preview pictures other than the target preview picture in the second page may be understood as a display style of the preview pictures other than the target preview picture in the second page when they are displayed in the preview region. When the target preview picture is displayed within the preview region, the preview pictures other than the target preview picture may not be displayed within the preview region, or at least part of the preview pictures other than the target preview picture may be displayed within the preview region at the same time, depending on the size of the preview region.

In some implementations, the target preview picture and the preview pictures other than the target preview picture in the second page may be displayed in different display styles, so that the current user can quickly determine the target preview picture. At this time, the interaction method provided in this embodiment may further include: displaying the target preview picture in a first display style, and displaying preview pictures other than the target preview picture in the preview region in a second display style, in response to the selection operation for the target module information. Here, the first display style and the second display style may be different. For example, the first display style may be a highlighted display, and the second display style may be a non-highlighted display.

In this embodiment, when the selection operation is finished, for example, after the current user moves the input indicator out of the display region of the target module information, the display of the target preview picture in the preview region may be maintained until a preview picture switching operation for the preview region is received or a selection operation for a piece of module information other than the target module information is received again. Alternatively, the preview picture displayed in the preview region prior to the current reception of the selection operation may also be redisplayed, or the preview picture of a preset page component in the second page may be displayed. This can be set as required.

S204: Adjust a first region size of the information region in response to a preset trigger operation acting on the information region, and adjust a second region size of the preview region based on the adjusted first region size.

Here, the preset trigger operation may be understood as a trigger operation for instructing to adjust the region size of the information region, such as a trigger operation for instructing to increase or decrease module information of the interaction modules displayed in an information region. The method of performing the preset trigger operation may be set flexibly. For example, the preset trigger operation may be an operation of triggering a preset control displayed in the information region. The first region size may be understood as a size of the information region, and the second region size may be understood as a size of the preview region.

Specifically, when a preset trigger operation acting on the information region 21 is received, the first region size of the information region 21 may be adjusted, and the second region size of the preview region 20 may be adjusted based on the adjusted first region size. For example, the first region size of the information region 21 may be increased, and the second region size of the preview region 20 may be increased or decreased based on the increased first region size. Alternatively, the first region size of the information region 21 may be decreased, and the second region size of the preview region 20 may be increased or decreased based on the decreased first region size.

In this embodiment, when the first region size and the second region size are adjusted, a number of pieces of module information displayed in the information region and/or an area of a preview picture displayed in the preview region may be adjusted or not be adjusted.

In some implementations, the interaction method provided in this embodiment may further include: adjusting a number of pieces of module information displayed in the information region, and/or adjusting an area of a preview picture displayed in the preview region, in response to the preset trigger operation acting on the information region. For example, when the first region size is increased, the number of pieces of module information displayed in the information region may be increased based on the increased first region size. When the first region size is decreased, the number of pieces of module information displayed in the information region may be reduced based on the decreased first region size. When the second region size is increased, the area of the preview picture displayed in the preview region may be enlarged based on the increased second region size, that is, more of the preview picture may be displayed. When the second region size is decreased, the area of the preview picture displayed in the preview region may be reduced based on the decreased second region size, that is, less of the preview picture may be displayed.

The method of adjusting the first region size may be set as required. For example, when the first region size is to be increased, a region size to which the information region needs to be increased may be determined based on a number of pieces of module information that has not yet been displayed in the information region and a default display size of the module information, and the first region size of the information region may be increased to this region size, so as to display, in the information region, all the module information to be displayed in the information region. When the first region size is to be decreased, a region size to which the information region needs to be decreased may be determined based on a number of pieces of module information displayed by default in the information region and a default display size of the module information, and the first region size of the information region may be decreased to this region size, that is, the first region size is restored to an original region size before the first region size is increased.

Optionally, the second region size is positively correlated with the first region size, and the area of the preview picture displayed in the preview region is positively correlated with the second region size.

For example, when it is detected that the current user triggers a preset control 24 within the information region 21 (as shown in FIG. 2) when the module information is not fully displayed, a height of the information region 21 may be increased, and module information of all the interaction modules to be displayed may be displayed in the information region 21 with the increased height. Meanwhile, a height of the preview region 20 is increased based on the increased height of the information region 21, so as to enlarge the area of the preview picture displayed in the preview region 20, as shown in FIG. 4.

Furthermore, after the height of the information region 21 is increased, when it is detected that the current user triggers the preset control 24 within the information region 21 again, the information region 21 may be restored to a state before the height is increased, the height of the preview region 20 may be restored to an original height before the height is increased, and the number of pieces of module information displayed in the information region 21 may be restored to an original number before the height is increased.

The interaction method provided in this embodiment enables a user to view preview pictures corresponding to different module information, and enables the user to view module information of different interaction modules, which can further diversify the interaction method of the first page and meet the user's various viewing requirements.

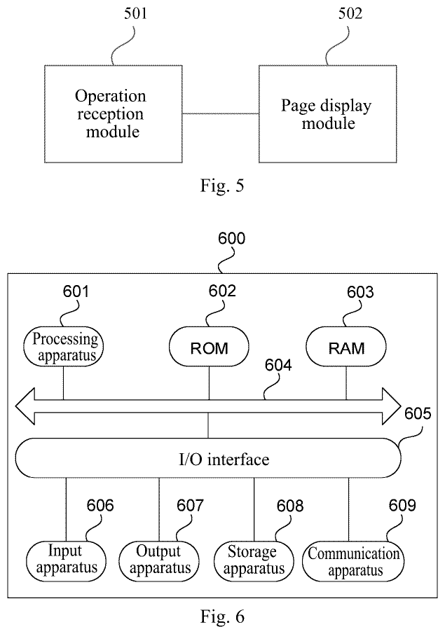

FIG. 5 is a structural block diagram of an interaction apparatus according to an embodiment of the present disclosure. The apparatus may be implemented by software and/or hardware, and may be configured in an electronic device, typically in a mobile phone or a tablet computer. By performing the interaction method, the apparatus may display, in a page, module information and a preview picture of an interaction module corresponding to another page, for example, the apparatus may display a preview picture of a virtual venue in a display page for activity promotion information in the virtual venue. As shown in FIG. 5, the interaction apparatus provided in this embodiment may include: an operation reception module 501 and a page display module 502. The operation reception module 501 is configured to receive a display operation for a first page; and the page display module 502 is configured to display the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

The interaction apparatus provided in this embodiment receives, by the operation reception module, the display operation for the first page; and displays, by the page display module, the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region. According to the above-mentioned technical solution employed in the embodiment of the present disclosure, when module information of an interaction module is displayed on the first page, a preview picture corresponding to the second page is displayed in association with the module information selected by the user, thus enabling the user to quickly view the preview pictures corresponding to different module information and to quickly know and switch to the second page. In this way, content displayed on the first page and the method of displaying the preview pictures can be diversified, and the difficulty for the user to view the preview pictures corresponding to different interaction modules and switch to the second page can be reduced.

Further, the interaction apparatus provided in this embodiment may further include: a picture adjustment module configured to adjust, in response to a selection operation for target module information, a target preview picture corresponding to the target module information into the preview region for display after the displaying the first page, where the target preview picture is a preview picture corresponding to the second page, and module information of different interaction modules corresponds to different preview pictures.

In the above-mentioned solution, the picture adjustment module may be further configured to: display the target preview picture in a first display style, and display preview pictures other than the target preview picture in the preview region in a second display style, in response to the selection operation for the target module information.

In the above-mentioned solution, the selection operation may include an operation of enabling an input indicator to hover over the target module information. The interaction apparatus provided in this embodiment may further include: a picture switch module configured to, after the displaying the first page, switch a preview picture displayed in the preview region in response to a preview picture switching operation for the preview region.

Further, the interaction apparatus provided in this embodiment may further include: a size adjustment module configured to, after the displaying the first page, adjust a first region size of the information region in response to a preset trigger operation acting on the information region, and adjust a second region size of the preview region based on the adjusted first region size.

In the above-mentioned solution, the size adjustment module may be further configured to: adjust a number of pieces of module information displayed in the information region, and/or adjust an area of a preview picture displayed in the preview region, in response to the preset trigger operation acting on the information region.

In the above-mentioned solution, the second region size may be positively correlated with the first region size, and the area of the preview picture displayed in the preview region may be positively correlated with the second region size.

In the above-mentioned solution, the interaction module may have a corresponding page component in the second page, and the preview picture corresponding to the module information of the interaction module may be the preview picture of the page component corresponding to the respective interaction module. The interaction module may be an activity promotion module, and the module information may be activity promotion information.

The interaction apparatus provided in the embodiment of the present disclosure may perform the interaction method provided in any embodiment of the present disclosure, and has corresponding functional modules for performing the interaction method and beneficial effects. For technical details not described in detail in this embodiment, reference may be made to the interaction method provided in any embodiment of the present disclosure.

Reference is made to FIG. 6 below, which is a schematic structural diagram of an electronic device (such as a terminal device) 600 suitable for implementing an embodiment of the present disclosure. A terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (e.g., a vehicle navigation terminal), and fixed terminals such as a digital TV and a desktop computer. The electronic device shown in FIG. 6 is merely an example, and shall not impose any limitation on the function and scope of use of the embodiments of the present disclosure.

As shown in FIG. 6, the electronic device 600 may include a processing apparatus (for example, a central processing unit or a graphics processing unit) 601 that may perform a variety of appropriate actions and processing in accordance with a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to one another through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, an embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 609, installed from the storage apparatus 608, or installed from the ROM 602. When the computer program is executed by the processing apparatus 601, the above-mentioned functions defined in the method of the embodiment of the present disclosure are performed.

It should be noted that the above-mentioned computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), an end-to-end network (for example, an ad hoc end-to-end network), and any currently known or future-developed network.

The above-mentioned computer-readable medium may be contained in the above-mentioned electronic device. Alternatively, the computer-readable medium may exist independently, without being assembled into the electronic device.

The above-mentioned computer-readable medium carries one or more programs that, when executed by the electronic device, cause the electronic device to: receive a display operation for a first page; and display the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. The name of a module does not constitute a limitation on the unit itself in some cases.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, Example 1 provides an interaction method, including: receiving a display operation for a first page; and displaying the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

According to one or more embodiments of the present disclosure, Example 2 is based on the method of Example 1, where, after the displaying the first page, the method further includes: adjusting, in response to a selection operation for target module information, a target preview picture corresponding to the target module information into the preview region for display, where the target preview picture is a preview picture corresponding to the second page, and module information of different interaction modules corresponds to different preview pictures.

According to one or more embodiments of the present disclosure, Example 3 is based on the method of Example 2, where the method further includes: displaying the target preview picture in a first display style, and displaying preview pictures other than the target preview picture in the preview region in a second display style, in response to the selection operation for the target module information.

According to one or more embodiments of the present disclosure, Example 4 is based on the method of Example 2, where the selection operation includes an operation of enabling an input indicator to hover over the target module information; and after the displaying the first page, the method further includes: switching a preview picture displayed in the preview region in response to a preview picture switching operation for the preview region.

According to one or more embodiments of the present disclosure, Example 5 is based on the method of Example 1, where, after the displaying the first page, the method further includes: adjusting a first region size of the information region in response to a preset trigger operation acting on the information region, and adjusting a second region size of the preview region based on the adjusted first region size.

According to one or more embodiments of the present disclosure, Example 6 is based on the method of Example 5, where the method further includes: adjusting a number of pieces of module information displayed in the information region, and/or adjusting an area of a preview picture displayed in the preview region, in response to the preset trigger operation acting on the information region.

According to one or more embodiments of the present disclosure, Example 7 is based on the method of Example 6, where the second region size is positively correlated with the first region size, and the area of the preview picture displayed in the preview region is positively correlated with the second region size.

According to one or more embodiments of the present disclosure, Example 8 is based on the method of any one of Examples 1 to 7, where the interaction module has a corresponding page component in the second page, and the preview picture corresponding to the module information of the interaction module is the preview picture of the page component corresponding to the respective interaction module; and the interaction module is an activity promotion module, and the module information is activity promotion information.

According to one or more embodiments of the present disclosure, Example 9 provides an interaction apparatus, including: an operation reception module configured to receive a display operation for a first page; and a page display module configured to display the first page in response to the display operation, where the first page includes a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

According to one or more embodiments of the present disclosure, Example 10 provides an electronic device, including: one or more processors; and a memory configured to store one or more programs, where the one or more programs, when executed by the one or more processors, cause the one or more processors to implement the interaction method according to any one of Examples 1 to 8.

According to one or more embodiments of the present disclosure, Example 11 provides a computer-readable storage medium having a computer program stored thereon, where the computer program, when executed by a processor, causes the interaction method according to any one of Examples 1 to 8 to be implemented.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. An interaction method, comprising:
receiving a display operation for a first page; and
displaying the first page in response to the display operation, wherein the first page comprises a preview region and an information region, a preview picture corresponding to a second page is displayed in the preview region, module information of at least part of interaction modules corresponding to the second page is displayed in the information region, and the preview picture displayed in the preview region corresponds to module information in a selected state in the information region.

2. The method according to claim 1, wherein after the displaying the first page, the method further comprises:
adjusting, in response to a selection operation for target module information, a target preview picture corresponding to the target module information into the preview region for display, wherein the target preview picture is a preview picture corresponding to the second page, and preview pictures corresponding to module information of different interaction modules are different.

3. The method according to claim 2, further comprising:
in response to the selection operation for the target module information, displaying the target preview picture in a first display style, and displaying preview pictures other than the target preview picture in the preview region in a second display style.

4. The method according to claim 2, wherein the adjusting a target preview picture corresponding to the target module information into the preview region for display comprises:
switching the preview picture displayed in the preview region to display the target preview page in the preview region.

5. The method according to claim 4, wherein the switching the preview picture displayed in the preview region to display the target preview page in the preview region comprises:
controlling, based on a relative position in the second page between a page component of the preview picture displayed in the preview region and a page component corresponding to an interaction module which corresponds to the target module information, the preview picture displayed in the preview region to move until the target preview picture of the page component corresponding to the interaction module is moved to a preset position of the preview region for display.

6. The method according to claim 1, wherein after the displaying the first page, the method further comprises:
in response to a preset trigger operation on the information region, adjusting a first region size of the information region, and adjusting a second region size of the preview region based on the adjusted first region size.

7. The method according to claim 6, further comprising:
in response to the preset trigger operation acting on the information region, adjusting a number of pieces of module information displayed in the information region, and/or adjusting an area of the preview picture displayed in the preview region.

8. The method according to claim 7, wherein the adjusting a number of pieces of module information displayed in the information region in response to the preset trigger operation on the information region comprises:
when the first region size is increased, increasing, based on the increased first region size, the number of pieces of module information displayed in the information region; and
when the first region size is decreased, reducing, based on the decreased first region size, the number of pieces of module information displayed in the information region.

9. The method according to claim 7, wherein the adjusting an area of the preview picture displayed in the preview region in response to the preset trigger operation on the information region, comprises:
when the second region size is increased, enlarging, based on the increased second region size, the area of the preview picture displayed in the preview region; and
when the second region size is decreased, reducing, based on the decreased second region size, the area of the preview picture displayed in the preview region.

10. The method according to claim 7, wherein the second region size is positively correlated with the first region size, and the area of the preview picture displayed in the preview region is positively correlated with the second region size.

11. The method according to claim 8, further comprising:
after a height of the information region is increased, when it is detected that the preset trigger operation is performed on the information region again, restoring the information region to a state before the height is increased, restoring a height of the preview region to an original height before the height is increased, and restoring the number of pieces of module information displayed in the information region to an original number before the height is increased.

12. The method according to claim 1, wherein at least one of the interaction modules has a corresponding page component in the second page, and the preview picture corresponding to the module information of the at least one interaction module is a preview picture of a page component corresponding to the respective interaction module;
the at least one interaction module is an activity promotion module, and the module information is activity promotion information.

13. (canceled)

14. An electronic device, comprising:
at least one processor; and
a memory communicatively connected to the at least one processor,
wherein the memory stores a computer program executable by the at least one processor, and the computer program, when executed by the at least one processor, causes the at least one processor to perform an interaction method comprising:
receiving a display operation for a first page; and
displaying the first page in response to the display operation, wherein the first page comprises a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

15. A non-transitory_computer-readable storage medium, storing computer instructions that, when executed by a processor, cause an interaction method to be implemented, the interaction method comprising:
receiving a display operation for a first page; and
displaying the first page in response to the display operation, wherein the first page comprises a preview region and an information region, the preview region is used for displaying a preview picture corresponding to a second page, the information region is used for displaying module information of at least part of interaction modules corresponding to the second page, and the preview picture displayed in the preview region corresponds to module information in a selected state in the information region.

16. The method according to claim 1, wherein the module information in the selected state comprises an object adding control;
the method further comprises:
in response to a triggering operation on the object adding control, adding an object to be displayed to an interaction module corresponding to the module information in the selected state, and
displaying in the preview region a preview picture of the object to be displayed displaying in the second page.

17. The method according to claim 1, wherein the selection operation comprises an operation of hovering an input indicator over the target module information;
after displaying the first page, the method further comprises:
switching the preview picture displayed in the preview region in response to a preview picture switching operation for the preview region.

18. The method according to claim 2, wherein the selection operation comprises an operation of hovering an input indicator over the target module information.

19. The electronic device according to claim 14, wherein, after the displaying the first page, the method further comprises:
adjusting, in response to a selection operation for target module information, a target preview picture corresponding to the target module information into the preview region for display, wherein the target preview picture is a preview picture corresponding to the second page, and preview pictures corresponding to module information of different interaction modules are different.

20. The electronic device according to claim 19, the method further comprising:
in response to the selection operation for the target module information, displaying the target preview picture in a first display style, and displaying preview pictures other than the target preview picture in the preview region in a second display style.

21. The electronic device according to claim 14, wherein the module information in the selected state comprises an object adding control;
the method further comprises:
in response to a triggering operation on the object adding control, adding an object to be displayed to an interaction module corresponding to the module information in the selected state, and
displaying in the preview region a preview picture of the object to be displayed displaying in the second page.
